(19) United States
(12) Patent Application Publication
(10) Pub. No.: US 2023/0327385 A1
(43) Pub. Date: Oct. 12, 2023

(54) POWER ADAPTER

(71) Applicant: EVGA CORPORATION, New Taipei City (TW)

(72) Inventor: Tai-Sheng HAN, New Taipei City (TW)

(21) Appl. No.: 18/193,666

(22) Filed: Mar. 31, 2023

(30) Foreign Application Priority Data
Apr. 6, 2022 (TW) 111203453

(51) Int. Cl. H01R 31/06; H01R 4/42; H01R 13/518

(52) U.S. Cl. CPC H01R 31/06; H01R 4/42; H01R 13/621; H01R 2201/06; H01R 13/518

(57) ABSTRACT

A power adapter includes a housing, at least one conductive bar, a first electrical connector, and a fixing assembly. The conductive bar is disposed in the housing. The first electrical connector is movably disposed on one side of the housing and includes at least one electrical contact portion extending into the housing. The fixing assembly is movably disposed on the housing and includes two clamping members and an actuating member. The actuating member is configured to move the clamping members toward each other, so as to make the conductive bar and the electrical contact portion to abut against each other.

### CROSS-REFERENCE TO RELATED APPLICATION

This application claims priority to Taiwan Application Serial Number 111203453, filed Apr. 6, 2022, which is herein incorporated by reference.

### BACKGROUND

### Technical Field

The present disclosure relates to a power adapter, and more particularly, to a power adapter capable of changing the position of an electrical connector.

### Description of Related Art

Nowadays, in addition to the central processing unit and memory as the core of information processing inside the computer, various peripheral devices (such as speakers, screens, data cards, sound cards, or display cards, etc.) are also the focus of computer data transmission and command control. The expansion slots can be installed with various interface cards to enable peripheral devices and computers to transmit data and be used for expansion purposes, such as peripheral component connection interface (PCI Card), industry standard architecture bus card (ISA Card), etc. Among them, for a display card, when it is placed on the computer motherboard, it often happens that due to the size of the space, it will get stuck with the surrounding electronic components when it is connected to the external power supply. In short, there is not enough space to install an external power supply. If you bend the power cord forcibly to insert it, it may cause problems such as breaking the power cord or detaching from the connector.

Accordingly, how to provide a power adapter to solve the aforementioned problems becomes an important issue to be solved by those in the industry.

### SUMMARY

An aspect of the disclosure is to provide a power adapter that can efficiently solve the aforementioned problems.

According to an embodiment of the disclosure, a power adapter includes a housing, at least one conductive bar, a first electrical connector, and a fixing assembly. The conductive bar is disposed in the housing. The first electrical connector is movably disposed on one side of the housing and includes at least one electrical contact portion extending into the housing. The fixing assembly is movably disposed on the housing and includes two clamping members and an actuating member. The actuating member is configured to move the clamping members toward each other, so as to make the conductive bar and the electrical contact portion to abut against each other.

In an embodiment of the disclosure, a number of the at least one conductive bar and a number of the at least one electrical contact portion are both two. The conductive bars are arranged between the electrical contact portions.

In an embodiment of the disclosure, the conductive bars respectively pass through the two clamping members.

In an embodiment of the disclosure, the housing has two slotted holes. The electrical contact portions respectively pass through the slotted holes.

In an embodiment of the disclosure, the actuating member is screwed to one of the two clamping members and abuts against another of the two clamping members. When the actuating member rotates relative to the one of the two clamping members along a rotational direction, the one of the two clamping members moves toward the another of the two clamping members.

In an embodiment of the disclosure, the fixing assembly further includes an elastic member abutted between the two clamping members.

In an embodiment of the disclosure, the elastic member is a spring and is sleeved on the actuating member.

In an embodiment of the disclosure, one of the two clamping members has a protrusion. Another of the two clamping members has a groove. The protrusion is at least partly located in the groove.

In an embodiment of the disclosure, the power adapter further includes a second electrical connector disposed on another side of the housing. The first electrical connector and the second electrical connector are electrically connected through the at least one conductive bar.

In an embodiment of the disclosure, the first electrical connector includes a plurality of first inserting portions. The second electrical connector includes a plurality of second inserting portions. A number of the first inserting portions is different from a number of the second inserting portions.

In an embodiment of the disclosure, the housing has a slotted hole. The actuating member passes through the slotted hole.

In an embodiment of the disclosure, the power adapter further includes a cover covering the slotted hole.

In an embodiment of the disclosure, the first electrical connector includes a cantilever and a positioning protrusion. The cantilever extends away from the housing. The positioning protrusion is disposed at a distal end of the cantilever and has an arc-shaped abutting surface.

In an embodiment of the disclosure, the housing has at least one fastening hole. The power adapter further includes a fixing bracket and a fastening member. The fixing bracket has a slotted hole and is configured to be mutually fixed with an object. The fastening member passes through the slotted hole and is fastened to the at least one fastening hole, and is configured to clamp the fixing bracket between the housing and the fastening member.

In an embodiment of the disclosure, the fixing bracket includes a first plate portion and a second plate portion. The first plate portion is configured to abut against the housing. The slotted hole is formed on the first plate portion. The second plate portion is connected to the first plate portion and bent relative to the first plate portion, and is configured to abut against the object.

According to an embodiment of the disclosure, a power adapter includes a housing, at least one conductive bar, a first electrical connector, and a second electrical connector. The at least one conductive bar is disposed in the housing. The first electrical connector is movably disposed on one side of the housing and includes at least one electrical contact portion extending into the housing. The at least one electrical contact portion is configured to abut against the at least one conductive bar. The second electrical connector is disposed on another side of the housing. The first electrical connector and the second electrical connector are electrically connected through the at least one conductive bar.

Accordingly, in the power adapter of the present disclosure, by operating the actuating member of the fixing assembly to move the two clamping members of the fixing assembly towards each other, the conductive bar fixed in the housing of the power adapter and the electrical contact portion of the first electrical connector can be clamped between the two clamping members, and the relative position of the conductive bar and the first electrical connector can be fixed. Relatively, by operating the actuating member to move the two clamping members in opposite directions, the two clamping members can release the conductive bar and the first electrical connector, thereby allowing the first electrical connector to move relative to the housing. By making the two clamping members respectively have a protrusion and a groove, and making the protrusion at least partly located in the groove, it is possible to prevent the two clamping members from deviating so that the conductive bar and the electrical contact portion cannot be correctly clamped. By abutting the elastic member between the two clamping members, in addition to exerting a reverse force on the two clamping members to assist alignment, the two clamping members can be stabilized without shaking. When the first electrical connector is plugged into the power port of an external object (such as a display card), the snapping feel generated by the positioning protrusion disposed on the cantilever of the first electrical connector snapping to the snapping structure on the external object can prompt the user that the first electrical connector has been correctly plugged into the external object. In addition, by making the positioning protrusion buckle against the aforementioned snapping structure with an arc-shaped abutting surface, the user only needs to simply pull the power adapter away from the external object to release the fastening relationship between the positioning protrusion and the aforementioned specific structure, and separate the first electrical connector from the power port of the external object. By fixing the fixing bracket between the housing and the external object, auxiliary support can be provided for the connection between the first electrical connector and the power port, so as to prevent the first electrical connector from being broken or separated from the power port.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a power adapter according to an embodiment of the present disclosure;

FIG. 2 is another perspective view of the power adapter in FIG. 1;

FIG. 3 is a top view showing the power adapter in FIG. 1 plugging with a display card;

FIG. 4 is a top view showing the power adapter in FIG. 1 plugging with another display card;

FIG. 5 is a side view of a first electrical connector in FIG. 1;

FIG. 6 is a partial cross-sectional view of the power adapter in FIG. 1;

FIG. 7 is another partial cross-sectional view of the power adapter in FIG. 1;

FIG. 8 is a perspective view of a power adapter according to another embodiment of the present disclosure;

FIG. 9 is another perspective view of the power adapter in FIG. 8;

FIG. 10 is a top view showing the power adapter in FIG. 8 plugging with a display card; and

FIG. 11 is a top view showing the power adapter in FIG. 8 plugging with another display card.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

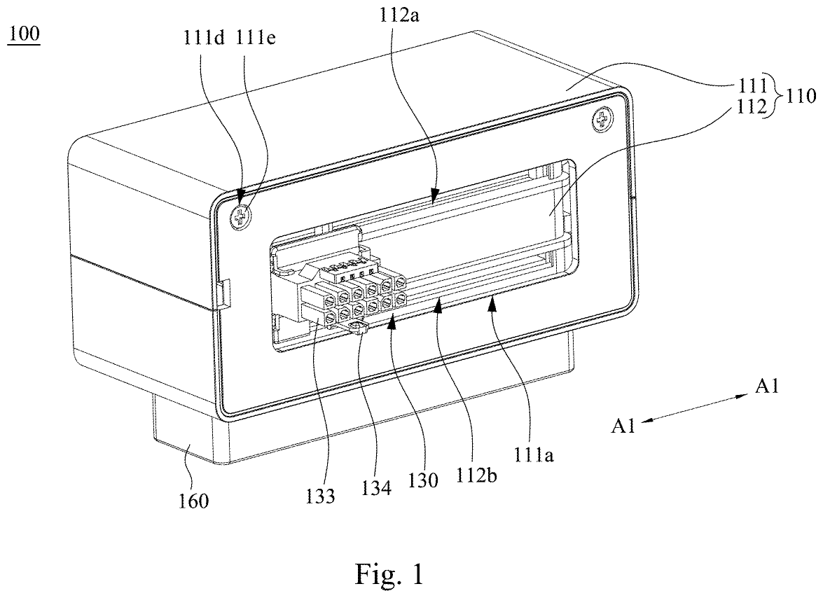

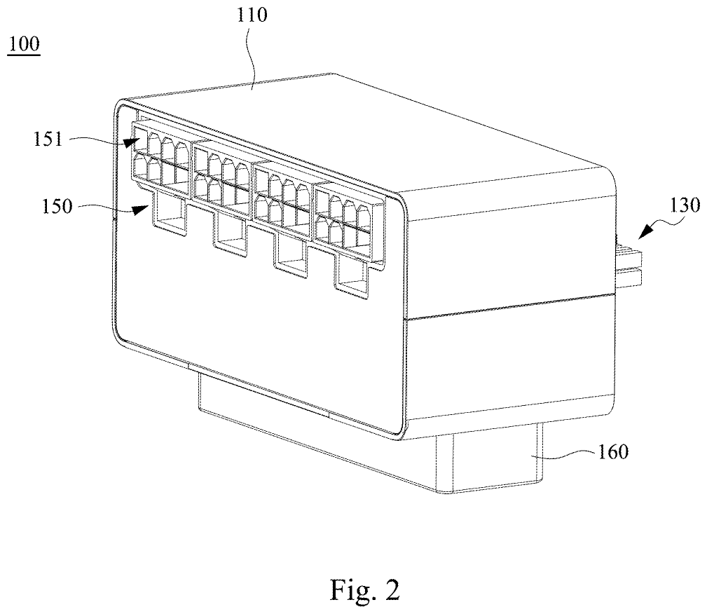

Reference is made to FIGS. 1 and 2. FIG. 1 is a perspective view of a power adapter 100 according to an embodiment of the present disclosure. FIG. 2 is another perspective view of the power adapter 100 in FIG. 1. As shown in FIGS. 1 and 2, in the present embodiment, the power adapter 100 includes a housing 110, a first electrical connector 130, and a plurality of second electrical connectors 150. The first electrical connector 130 is movably disposed on one side of the housing 110. Specifically, as shown in FIG. 1, the first electrical connector 130 is able to move to different positions relative to the housing 110 along a direction A1. The second electrical connectors 150 are fixed on another side of the housing 110. The aforementioned two sides are opposite sides of the housing 110, but the disclosure is not limited thereto. The first electrical connector 130 is configured to be plugged into a power port of an external object (such as a display card), and the second electrical connectors 150 can be plugged into an external connector connected to an external power supply. In this way, the power of the external power supply can be supplied to the external object through the power adapter 100.

As shown in FIGS. 1 and 2, in the present embodiment, numbers of the first electrical connector 130 and the second electrical connectors 150 are different. For example, the number of the first electrical connector 130 is one, and the number of the second electrical connectors 150 is four, but the present disclosure is not limited thereto. In other embodiments, the power adapter 100 has two first electrical connectors 130 and five second electrical connectors 150.

As shown in FIGS. 1 and 2, in the present embodiment, the first electrical connector 130 includes a plurality of first inserting portions 133. Each of the second electrical connectors 150 includes a plurality of second inserting portions 151. A number of the first inserting portions 133 is different from a number of the second inserting portions 151 of each of the second electrical connectors 150. For example, the number of first inserting portions 133 included in the first electrical connector 130 is sixteen, and the number of second inserting portions 151 included in each of the second electrical connectors 150 is eight, but the present disclosure is not limited thereto.

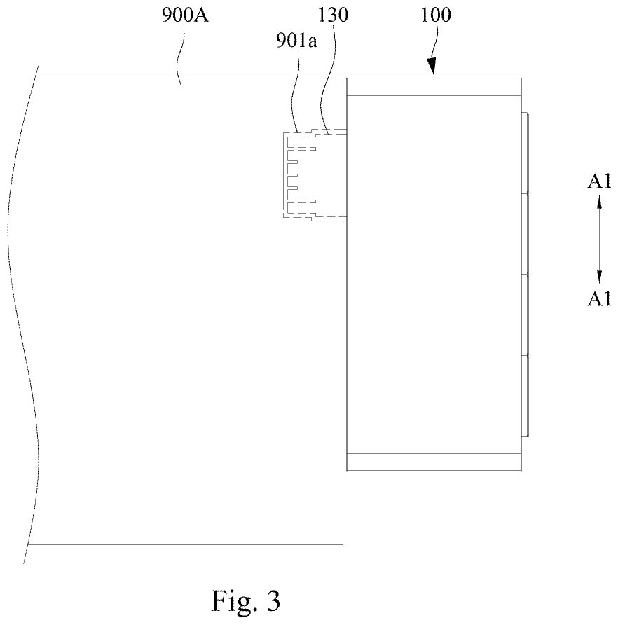

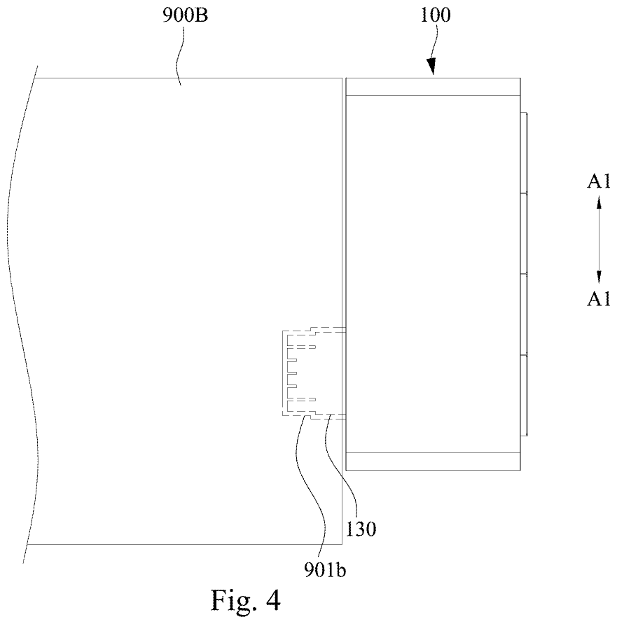

Reference is made to FIGS. 3 and 4. FIG. 3 is a top view showing the power adapter 100 in FIG. 1 plugging with a display card 900A. FIG. 4 is a top view showing the power adapter 100 in FIG. 1 plugging with another display card 900B. As shown in FIGS. 3 and 4, the display cards 900A, 900B have power ports 901a, 901b, respectively. The power ports 901a, 901b are configured to be plugged into by the first electrical connector 130. The positions of the power ports 901a, 901b in the direction A1 are different. As mentioned above, since the first electrical connector 130 is able to move to different positions relative to the housing 110 along the direction A1, after the first electrical connector 130 is plugged into the power port 901a or the power port 901b, the housing 110 of the power adapter 100 can move relative to the display card 900A or the display card 900B along the direction A1. In this way, the user can elastically adjust the relative position of the housing 110 and the display card 900A or the display card 900B (for example, make the housing 110 not protrude from the side of the display card 900A or the display card 900B).

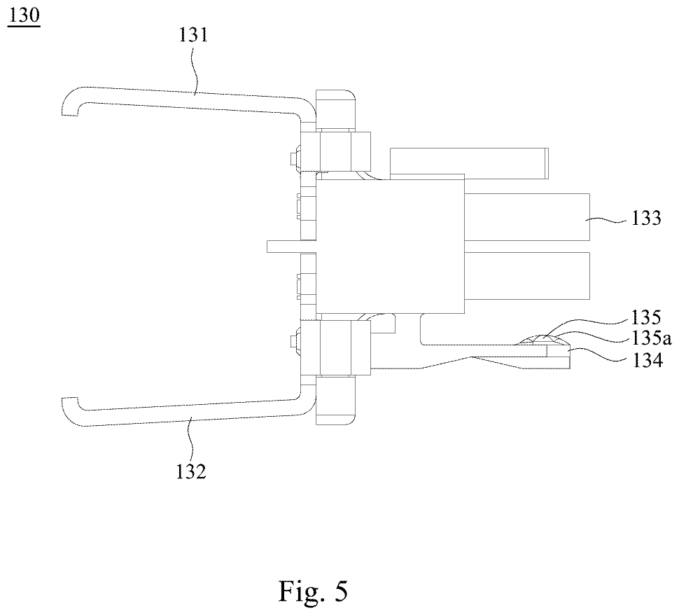

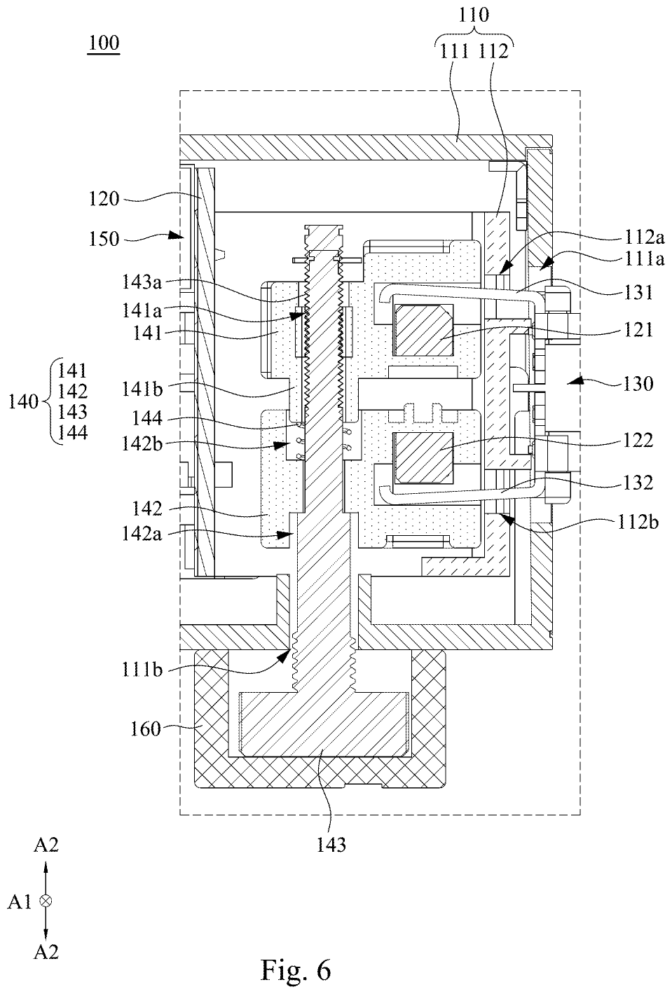

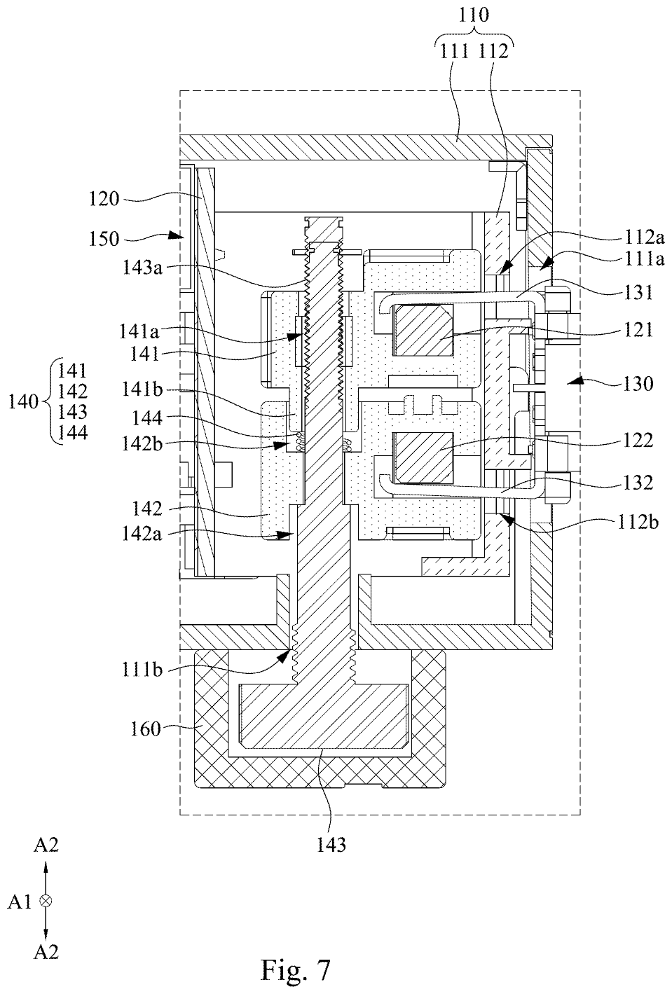

Reference is made to FIGS. 5, 6, and 7. FIG. 5 is a side view of the first electrical connector 130 in FIG. 1. FIG. 6 is a partial cross-sectional view of the power adapter 100 in FIG. 1. FIG. 7 is another partial cross-sectional view of the power adapter 100 in FIG. 1. As shown in FIGS. 5, 6, and 7, in the present embodiment, the power adapter 100 further includes a circuit board 120 and a fixing assembly 140. The circuit board 120 is disposed in the housing 110 and includes two conductive bars 121, 122. The two conductive bars 121, 122 are disposed on a surface of the circuit board 120. The second electrical connectors 150 are connected to another surface of the circuit board 120. The first electrical connector 130 and the second electrical connectors 150 are electrically connected through the circuit board 120 provided with the conductive bars 121, 122. The first electrical connector 130 includes two electrical contact portions 131, 132 extending into the housing 110. The two conductive bars 121, 122 extend parallel to the direction A1 and are sequentially arranged between the two electrical contact portions 131, 132 in the direction A2. In addition, with reference to FIG. 1, the housing 110 includes an outer portion 111 and an inner portion 112. The outer portion 111 has an opening 11a. The first electrical connector 130 extends into the outer portion 111 through the opening 111a. The inner portion 112 is disposed in the outer portion 111 and blocks the opening 111a to prevent foreign objects from entering the housing 110 through the opening 111a. The inner portion 112 includes two slotted holes 112a, 112b. The slotted holes 112a, 112b extend along the direction A1 and are exposed to the opening 111a. The two electrical contact portions 131, 132 of the first electrical connector 130 respectively pass through the slotted holes 112a, 112b to extend into the inner portion 112, and can move in the slotted holes 112a, 112b along the direction A1.

In some embodiments, the voltage difference between the two conductive bars 121, 122 is 12 volts, and one of the conductive bars 121, 122 is grounded, but the present disclosure is not limited thereto.

As shown in FIGS. 6 and 7, in the present embodiment, the fixing assembly 140 is movably disposed on the housing 110 and includes two clamping members 141, 142 and an actuating member 143. Specifically, the two electrical contact portions 131, 132 are inserted into the two clamping members 141, 142 respectively, and are retained by the two clamping members 141, 142 in the direction A1. Hence, the clamping members 141, 142 can move along the direction A1 together with the electrical contact portions 131, 132. In some embodiments, the conductive bars 121, 122 respectively pass through the clamping members 141, 142. Therefore, the clamping members 141, 142 can move in the direction A1 along the conductive bars 121, 122 respectively. In other words, the two clamping members 141, 142 respectively have front entrances for the two electrical contact portions 131, 132 to be inserted into, and have lateral through holes 272a respectively for the conductive bars 121, 122 to pass through.

As shown in FIGS. 6 and 7, in the present embodiment, the actuating member 143 is configured to move the clamping members 141, 142 toward each other, so as to make the conductive bars 121, 122 and the electrical contact portions 131, 132 to abut against each other, respectively. The actuating member 143 is further configured to move the clamping members 141, 142 in reverse, so that the conductive bars 121, 122 are separated from the electrical contact portions 131, 132, respectively. By operating the actuating member 143 to move the two clamping members 141, 142 toward each other, the conductive bars 121, 122 and the electrical contact portions 131, 132 can be clamped between the two clamping members 141, 142, and the relative positions of the conductive bars 121, 122 and the first electrical connector 130 can be fixed. Relatively, by operating the actuating member 143 to make the two clamping members 141, 142 reversely move, the two clamping members 141, 142 can release the conductive bars 121, 122 and the first electrical connector 130, thereby allowing the first electrical connector 130 to move relative to the housing 110.

As shown in FIGS. 6 and 7, in the present embodiment, the actuating member 143 is screwed to the clamping member 141 and abuts against the clamping member 142. Specifically, the clamping member 141 has a screw hole 141a, and the actuating member 143 has a threaded portion 143a that is screwed into the screw hole 141a. The actuating member 143 is provided with a buckle at the end of the clamping member 141 away from the clamping member 142, so as to prevent the clamping member 141 from being disengaged from the end of the actuating member 143. The actuating member 143 passes through the clamping member 142, and the clamping member 142 is located between the actuating member 143 and the clamping member 141. A counterbore 142a is formed on a side of the clamping member 142 away from the clamping member 141. The actuating member 143 has a stepped portion located in the counterbore 142a and abutting against the bottom of the counterbore 142a in the direction A2. When the actuating member 143 rotates relative to the clamping member 141 along a rotation direction (e.g., clockwise), the clamping member 141 moves toward the clamping member 142. When the actuating member 143 rotates relative to the clamping member 141 along another rotation direction (e.g., counterclockwise), the clamping member 141 moves away from the clamping member 142.

As shown in FIGS. 6 and 7, in the present embodiment, the outer portion 111 of the housing 110 has a slotted hole 111b. The slotted hole 111b extends along the direction A1. The actuating member 143 passes through the housing 110 through the slotted hole 111b. For example, the shape of the actuating member 143 is similar to that of a thumb screw, which is convenient for the user to directly rotate without tools, but the present disclosure is not limited thereto. In addition, the fixing assembly 140 further includes a cover 160. The cover 160 is detachably fixed to the outer portion 111 of the housing 110 and covers the slotted hole 111b and the actuating member 143, so as to prevent the fixing assembly 140 from loosening due to accidental touch or impact.

As shown in FIGS. 6 and 7, in the present embodiment, the clamping member 141 has a protrusion 141b. The clamping member 142 has a groove 142b. The protrusion 141b is at least partially located in the groove 142b. In this way, it is possible to prevent the two clamping members 141, 142 from deviating so that the conductive bars 121, 122 and the electrical contact portions 131, 132 cannot be clamped correctly. In other embodiments, the protrusion 141b can be disposed on the clamping member 142, and the groove 142b can be disposed on the clamping member 141.

As shown in FIGS. 6 and 7, in the present embodiment, the fixing assembly 140 further includes an elastic member 144 abutted between the two clamping members 141, 142. In detail, the elastic member 144 is abutted between the protrusion 141b of the clamping member 141 and the bottom of the groove 142b of the clamping member 142. In the present embodiment, the elastic member 144 is a spring and sleeved on the actuating member 143, but the disclosure is not limited thereto. With this structural configuration, in addition to applying a reverse force to the two clamping members 141, 142 to assist alignment, the two clamping members 141, 142 can also be stabilized without shaking.

As shown in FIGS. 1 and 5, in the present embodiment, the first electrical connector 130 includes a cantilever 134 and a positioning protrusion 135. The cantilever 134 extends away from the housing 110. The positioning protrusion 135 is disposed at a distal end of the cantilever 134 and located on a side of the cantilever 134 facing the first inserting portions 133. The positioning protrusion 135 has an arc-shaped abutting surface 135a. When the first electrical connector 130 is plugged into the power port 901a of the display card 900A or the power port 901b of the display card 900B, the snapping feel generated by the positioning protrusion 135 disposed on the cantilever 134 of the first electrical connector 130 snapping to the snapping structure (not shown) on the display card 900A or the display card 900B can prompt the user that the first electrical connector 130 has been correctly plugged into the display card 900A or the display card 900B. In addition, by making the positioning protrusion 135 buckle against the aforementioned snapping structure with the arc-shaped abutting surface 135a, the user only needs to simply pull the power adapter 100 away from the display card 900A or the display card 900B to release the fastening relationship between the positioning protrusion 135 and the aforementioned specific structure, and separate the first electrical connector 130 from the power port 901a of the display card 900A or the power port 901b of the display card 900B.

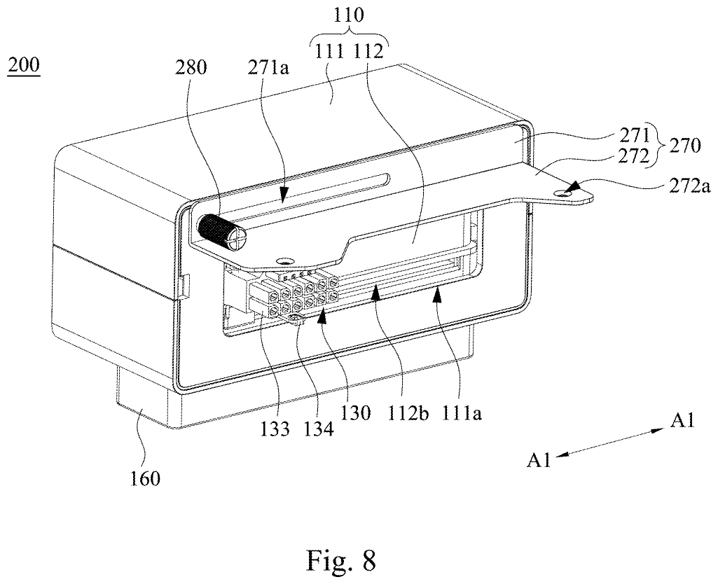

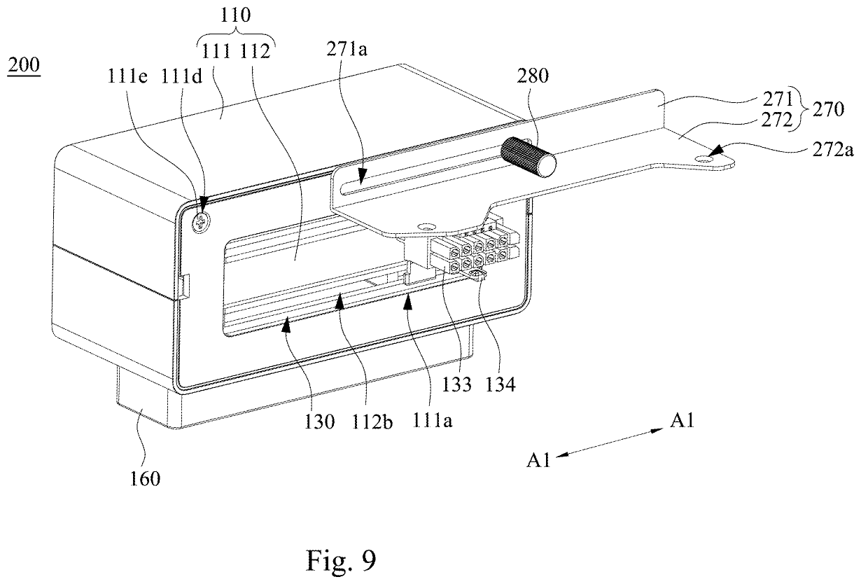

Reference is made to FIGS. 8 and 9. FIG. 8 is a perspective view of a power adapter 200 according to another embodiment of the present disclosure. FIG. 9 is another perspective view of the power adapter 200 in FIG. 8. As shown in FIGS. 8 and 9, in the present embodiment, in addition to all components of the power adapter 100 shown in FIG. 1, the power adapter 200 further includes a fixing bracket 270 and a fastening member 280. In addition, as shown in FIG. 1, the housing 110 has a plurality of fastening holes 111d, which are respectively fastened by screws 111e. The power adapter 200 of the present embodiment can flexibly allow the user to replace one of the screws 111e with the fastening member 280 based on actual needs. The fixing bracket 270 has a slotted hole 271a. The fastening member 280 passes through the slotted hole 271a and is fastened to the fastening hole 111d, and is configured to clamp the fixing bracket 270 between the housing 110 and the fastening member 280. For example, the shape of the fastening member 280 is similar to that of a thumb screw, which is convenient for the user to turn directly without tools, but the present disclosure is not limited thereto. Relatively, when the fastening member 280 is rotated to release the fixing bracket 270 between the housing 110 and the fastening member 280, the fixing bracket 270 can move along the direction A1 relative to the housing 110.

As shown in FIGS. 8 and 9, in the present embodiment, the fixing bracket 270 includes a first plate portion 271 and a second plate portion 272. The first plate portion 271 is configured to abut against the housing 110. The slotted hole 271a is formed on the first plate portion 271. The second plate portion 272 is connected to the first plate portion 271 and bent relative to the first plate portion 271.

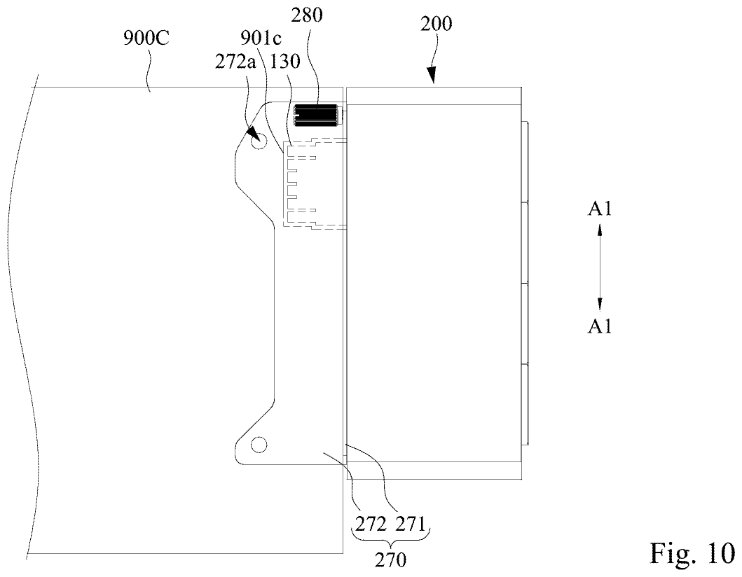

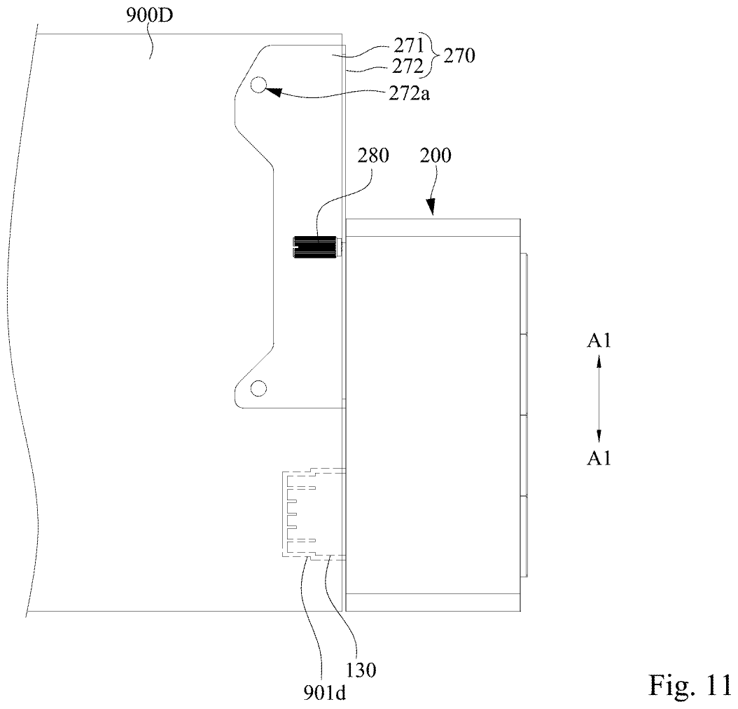

Reference is made to FIGS. 10 and 11. FIG. 10 is a top view showing the power adapter 200 in FIG. 8 plugging with a display card 900C. FIG. 11 is a top view showing the power adapter 200 in FIG. 8 plugging with another display card 900D. As shown in FIGS. 10 and 11, in the present embodiment, the display cards 900C, 900D have power ports 901c, 901d, respectively. The power ports 901c, 901d are configured to be plugged into by the first electrical connector 130. The positions of the power ports 901c, 901d in the direction A1 are different. As mentioned above, since the first electrical connector 130 is able to move to different positions relative to the housing 110 along the direction A1, after the first electrical connector 130 is plugged into the power port 901c or the power port 901d, the housing 110 of the power adapter 200 can move relative to the display card 900C or the display card 900D along the direction A1. In this way, the user can elastically adjust the relative position of the housing 110 and the display card 900C or 900D (for example, make the housing 110 not protrude from the side of the display card 900C or the display card 900D). In addition, the second plate portion 272 of the fixing bracket 270 is configured to abut against the display card 900C or the display card 900D, and has a plurality of through holes 272a. In some embodiments, the display card 900C or the display card 900D may have at least one fixing hole (not shown, such as a screw hole). As mentioned above, since the fixing bracket 270 is able to move along the direction A1 relative to the housing 110, after the first electrical connector 130 is plugged into the power port 901c or the power port 901d, the user can elastically adjust the relative position between the fixing bracket 270 and the display card 900C or 900D, so that at least one through hole 272a is aligned with at least one fixing hole, and the fixing member (not shown, such as a screw) is fixed to the fixing hole through the through hole 272a to fix the second plate portion 272 to the display card 900C or 900D. In this way, the fixing bracket 270 can provide auxiliary support for the connection between the first electrical connector 130 and the power port 901c or the power port 901d, thereby preventing the first electrical connector 130 from being broken or detached from the power port 901c or the power port 901d.

According to the foregoing recitations of the embodiments of the disclosure, it can be seen that in the power adapter of the present disclosure, by operating the actuating member of the fixing assembly to move the two clamping members of the fixing assembly towards each other, the conductive bar fixed in the housing of the power adapter and the electrical contact portion of the first electrical connector can be clamped between the two clamping members, and the relative position of the conductive bar and the first electrical connector can be fixed. Relatively, by operating the actuating member to move the two clamping members in opposite directions, the two clamping members can release the conductive bar and the first electrical connector, thereby allowing the first electrical connector to move relative to the housing. By making the two clamping members respectively have a protrusion and a groove, and making the protrusion at least partly located in the groove, it is possible to prevent the two clamping members from deviating so that the conductive bar and the electrical contact portion cannot be correctly clamped. By abutting the elastic member between the two clamping members, in addition to exerting a reverse force on the two clamping members to assist alignment, the two clamping members can be stabilized without shaking. When the first electrical connector is plugged into the power port of an external object (such as a display card), the snapping feel generated by the positioning protrusion disposed on the cantilever of the first electrical connector snapping to the snapping structure on the external object can prompt the user that the first electrical connector has been correctly plugged into the external object. In addition, by making the positioning protrusion buckle against the aforementioned snapping structure with an arc-shaped abutting surface, the user only needs to simply pull the power adapter away from the external object to release the fastening relationship between the positioning protrusion and the aforementioned specific structure, and separate the first electrical connector from the power port of the external object. By fixing the fixing bracket between the housing and the external object, auxiliary support can be provided for the connection between the first electrical connector and the power port, so as to prevent the first electrical connector from being broken or separated from the power port.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power adapter, comprising:
a housing;
at least one conductive bar disposed in the housing;
a first electrical connector movably disposed on one side of the housing and comprising at least one electrical contact portion extending into the housing; and
a fixing assembly movably disposed on the housing and comprising:
two clamping members; and
an actuating member configured to move the clamping members toward each other, so as to make the at least one conductive bar and the at least one electrical contact portion to abut against each other.

2. The power adapter of claim 1, wherein a number of the at least one conductive bar and a number of the at least one electrical contact portion are both two, and the conductive bars are arranged between the electrical contact portions.

3. The power adapter of claim 2, wherein the conductive bars respectively pass through the two clamping members.

4. The power adapter of claim 2, wherein the housing has two slotted holes, and the electrical contact portions respectively pass through the slotted holes.

5. The power adapter of claim 1, wherein the actuating member is screwed to one of the two clamping members and abuts against another of the two clamping members, and when the actuating member rotates relative to the one of the two clamping members along a rotational direction, the one of the two clamping members moves toward the another of the two clamping members.

6. The power adapter of claim 5, wherein the fixing assembly further comprises an elastic member abutted between the two clamping members.

7. The power adapter of claim 6, wherein the elastic member is a spring and is sleeved on the actuating member.

8. The power adapter of claim 1, wherein one of the two clamping members has a protrusion, another of the two clamping members has a groove, and the protrusion is at least partly located in the groove.

9. The power adapter of claim 1, further comprising a second electrical connector disposed on another side of the housing, and the first electrical connector and the second electrical connector are electrically connected through the at least one conductive bar.

10. The power adapter of claim 9, wherein the first electrical connector comprises a plurality of first inserting portions, the second electrical connector comprises a plurality of second inserting portions, and a number of the first inserting portions is different from a number of the second inserting portions.

11. The power adapter of claim 1, wherein the housing has a slotted hole, and the actuating member passes through the slotted hole.

12. The power adapter of claim 11, further comprising a cover covering the slotted hole.

13. The power adapter of claim 1, wherein the first electrical connector comprises:
a cantilever extending away from the housing; and
a positioning protrusion disposed at a distal end of the cantilever and having an arc-shaped abutting surface.

14. The power adapter of claim 1, wherein the housing has at least one fastening hole, and the power adapter further comprises:
a fixing bracket having a slotted hole and configured to be mutually fixed with an object; and
a fastening member passing through the slotted hole and fastened to the at least one fastening hole, and configured to clamp the fixing bracket between the housing and the fastening member.

15. The power adapter of claim 14, wherein the fixing bracket comprises:
a first plate portion configured to abut against the housing, wherein the slotted hole is formed on the first plate portion; and
a second plate portion connected to the first plate portion and bent relative to the first plate portion, and configured to abut against the object.

16. A power adapter, comprising:
a housing;
at least one conductive bar disposed in the housing;
a first electrical connector movably disposed on one side of the housing and comprising at least one electrical contact portion extending into the housing, wherein the at least one electrical contact portion is configured to abut against the at least one conductive bar; and
a second electrical connector disposed on another side of the housing, wherein the first electrical connector and the second electrical connector are electrically connected through the at least one conductive bar.
